(19) United States
(12) Patent Application Publication
(10) Pub. No.: US 2026/0293818 A1
(43) Pub. Date: Oct. 1, 2026

(54) High-Density Cultivation System with Hybrid Network Communication, AI-Enhanced Monitoring, Nano Size Fogging Carbon dioxide Delivery, Smart Ventilation, Growth Lighting Control, Smart Dripping, and Regular Automation or AI Irrigation Systems

(71) Applicant: Xinxin Shan, Surrey (CA)

(72) Inventor: Xinxin Shan, Surrey (CA)

(73) Assignee: LED Smart Inc, Surrey (CA)

(21) Appl. No.: 19/094,019

(22) Filed: Mar. 28, 2025

(51) Int. Cl. A01G 9/26; A01G 7/02; A01G 7/04; A01G 9/24; A01G 13/10; A01G 27/00

(52) U.S. Cl. CPC A01G 9/26; A01G 7/02; A01G 7/045; A01G 9/241; A01G 9/247; A01G 9/249; A01G 13/10; A01G 27/003

(57) ABSTRACT

A high-density cultivation system includes configurable racks for growing strawberries, leafy greens, herbs, fruits, and flowers in single or multiple layers. The racks can be fixed, mobile, or modular, optionally featuring wheels or rails for space optimization. A hybrid network using Wi-Fi, thread, Bluetooth, Bluetooth mesh, PLC, and industrial networks provides comprehensive connectivity. Cameras and sensors offer real-time monitoring, enabling regular automation or AI-enhanced analysis for plant growth and early detection of pests or diseases. Nano size fogging CO₂, generated ultrasonically or equivalently, enhances plant photosynthesis, while smart ventilation maintains ideal airflow, temperature, and humidity. Growth lighting employs adjustable-spectrum LEDs (red, blue, white, far-red, UV), controlled manually, automatically, or via AI-based feedback. Smart dripping irrigation delivers precise water and nutrients through automation or AI. Optional robotic modules with pollination tools and deep UV emitters enable targeted pollination and pest control, increasing yield and efficiency.

### CROSS-REFERENCE TO RELATED APPLICATIONS

### US Patent Documents

U.S. Pat. No. 8,533,993B2 09/2013 Pettibone
U.S. Pat. No. 11,308,715B2 04/2022 Genty et al.
U.S. Pat. No. 10,349,584B2 07/2019 Itzhaky et al.
U.S. Pat. No. 9,010,022B2 04/2015 Brusatore
US20190307077A1 10/2019 Lert, J R. et al.
U.S. Pat. No. 10,846,843B2 11/2020 Gonzalez et al.
U.S. Pat. No. 10,182,537B1 01/2019 Buelow

### Other Publication

Marcelino, K. R. et al. Nanobubble technology applications in environmental and agricultural systems: Opportunities and challenges. Critical Reviews in Environmental Science and Technology, 53(14), 1378-1403. https://doi.org/10.1080/10643389.2022.2136931
Cheng, B. et al. Research on Positioning and Navigation System of Greenhouse Mobile Robot Based on Multi-Sensor Fusion. Sensors 2024, 24, 4998. https://doi.org/10.3390/s24154998
Fuentes, A. et al. A Robust Deep-Learning-Based Detector for Real-Time Tomato Plant Diseases and Pests Recognition. Sensors 2017, 17, 2022. https://doi.org/10.3390/s17092022
WO2018013161A1 01/2018 WHITCHER et al.

### BACKGROUND OF THE INVENTION

High-density cultivation systems are increasingly used in controlled environment agriculture to maximize yield, reduce resources, and improve product quality. Traditional systems, however, often rely on limited automation, single-mode network communication, and non-adaptive environmental controls. These limitations can lead to inefficiencies in managing plant growth, monitoring plant health, and responding to environmental changes or pest issues.

Moreover, conventional ventilation and carbon dioxide supply solutions may not effectively maintain optimal growth conditions in larger racks with multiple layers. Growth lighting (traditionally referred to as PAR lighting) is crucial but often lacks real-time color ratio adjustments. Additionally, the detection of pests, diseases, or harmful insects often relies on manual inspection, which may not be timely or efficient.

Accordingly, there is a need for an integrated, high-density cultivation system that leverages hybrid network communication, advanced AI-enhanced monitoring, nano size fogging CO₂ delivery, growth lighting control, and robust environmental management (including ventilation, irrigation, and dripping). Such a system should also include modular or mobile racks for space optimization, interactive robotic functionalities (e.g., pollination and pest elimination), and flexible operation through either regular automation or AI control.

### SUMMARY OF THE INVENTION

The present invention discloses a high-density cultivation system comprising a versatile rack system capable of being arranged as fixed, mobile, or modular units, either individually or in master-slave combinations. These racks may include wheels or rails for mobility and space optimization, accommodating one or multiple layers for cultivating strawberries, leafy greens, herbs, fruits, and flowers.

Integrated into this system is a hybrid network communication framework incorporating Wi-Fi, thread, Bluetooth, Bluetooth mesh, PLC, and other industrial networks, providing robust and precise connectivity between sensors, cameras, controllers, AI modules, and user interfaces.

The system employs AI-enhanced monitoring using strategically positioned cameras and sensors to conduct real-time plant growth analysis, enabling automated detection of pests, harmful insects, or diseases. Data collected from these monitoring devices facilitates precise adjustments through regular automation or AI-based control methods.

An advanced nano size fogging CO₂ delivery system, using ultrasonic or comparable devices, efficiently supplies CO₂ directly to plant environments, significantly improving photosynthetic efficiency. Complementary to this is a smart ventilation system designed to regulate and maintain optimal temperature, airflow, humidity, and atmospheric composition.

Growth lighting is provided by adjustable-spectrum LED arrays capable of emitting combinations of red, blue, white, far-red, and UV light. The intensity and spectral composition of these lights can be adjusted manually, via preprogrammed regular automation, or through AI-driven control algorithms, allowing optimization of plant growth conditions.

Irrigation and nutrient delivery are precisely managed through a smart dripping system, which is operable by either regular automation or AI control, delivering water and nutrients at optimal intervals and quantities directly to plant roots.

Additionally, the system may integrate interactive robotic units equipped for pollination and targeted pest and disease management using deep UV emitters. These robotic functions further enhance the operational efficiency, biosecurity, and productivity of the cultivation environment. Collectively, these integrated features provide a comprehensive and highly adaptable solution for controlled-environment agriculture, ensuring improved plant health, higher yields, and efficient resource utilization.

### BRIEF DESCRIPTION OF DRAWINGS

FIG. 1: Side-view of the high-density cultivation rack system, showing trays, lighting, ventilation, and CO₂ distribution.

FIG. 2: Network diagram illustrating communication among server, RTUs (remote terminal unit), sensors, cameras, and AI modules.

FIG. 3: Flow diagram of the CO₂ generation and distribution system with direct and fogging CO₂ pathways.

FIG. 4: Flow diagram of the drip irrigation system, including nutrient delivery, analysis, recycling, and RTU controls.

### DETAILED DESCRIPTION OF THE INVENTION

The present invention provides an optimized high-density cultivation system specifically designed to enhance growth conditions for crops such as strawberries, leafy greens, herbs, fruits, and flowers.

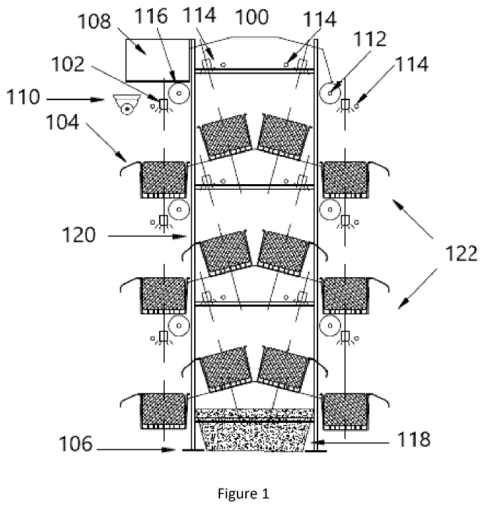

Referring now to FIG. 1, the high-density cultivation system includes a vertical Rack Assembly (100) composed of sturdy Rack Frames or Vertical Supports (120). The assembly efficiently holds multiple layers of Growth Trays (104) for plant cultivation. Each growth tray layer is equipped with specialized Lighting Modules (102) providing adjustable-spectrum LED illumination and a strategically placed Nano-sized Fogging CO₂ Spray Nozzle Pipeline (112) designed for enhanced foliar absorption of carbon dioxide. The rack may optionally include Stands or Wheels (106) for enhanced mobility. Each rack integrates comprehensive environmental monitoring, including Cameras and Sensors (110), enabling AI-enhanced or regular automated monitoring of plant growth. Essential elements for proper environmental control, such as the Ventilation Pipeline (116) and CO₂ Pipeline (114), are also integrated.

Additionally, the rack includes a dedicated Drainage/Collection Channel (118) for managing excess water or nutrients.

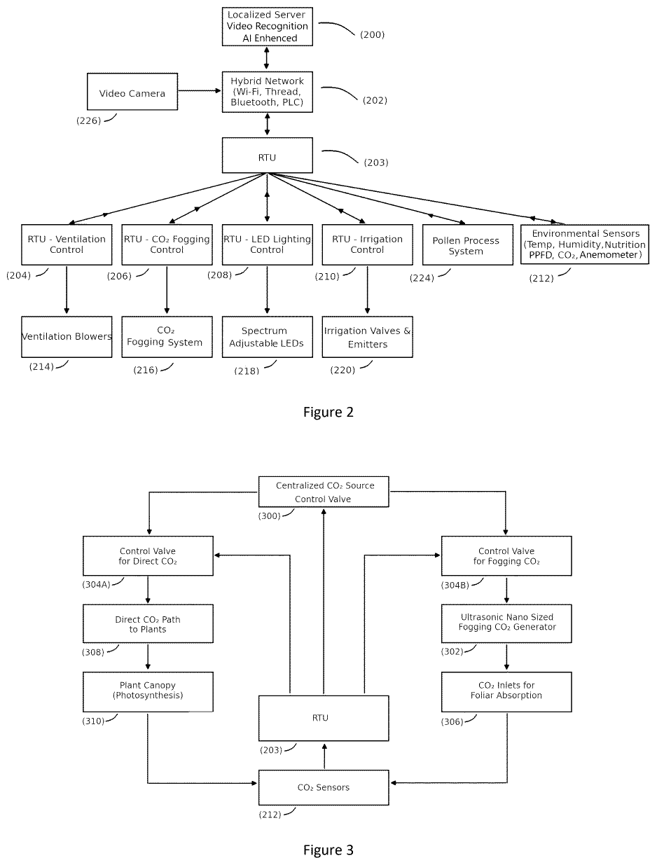

As illustrated in FIG. 2, the system incorporates advanced communication through a hybrid network configuration. This network includes a centralized Localized Server (200) interconnected via a Hybrid Network (202) using Wi-Fi, Thread, Bluetooth, PLC, and other suitable industrial communication protocols. The hybrid network connects directly to a dedicated Remote Terminal Unit (RTU) (203) positioned on each rack. This single RTU (203) effectively manages multiple subsystems, including Ventilation Control (204), CO₂ Fogging Control (206), LED Lighting Control (208), Irrigation Control (210), Environmental Sensors (212), and a Pollen Processing System (224). Additionally, the rack includes an integrated Video Camera (226) connected via the Hybrid Network, transmitting real-time imaging data to an AI Recognition Module (228). This AI module (228) processes the data for accurate plant recognition, growth stage detection, and fruit maturity assessment. The centralized control via the RTU ensures precise and responsive management of ventilation, CO₂ delivery, lighting spectrum, irrigation, environmental monitoring, and pollen management processes.

Turning now to FIG. 3, the invention provides a sophisticated CO₂ generation and distribution system. A Centralized CO₂ Source (300) delivers carbon dioxide gas through two controlled pathways. One pathway utilizes a dedicated Control Valve for Direct CO₂ (304A), directing pure CO₂ gas through the Direct CO₂ Path to Plants (308), enriching the air in the Plant Canopy (310) area to boost photosynthesis directly. The second pathway employs a Control Valve for Fogging CO₂ (304B), directing CO₂ to multiple rack-integrated Ultrasonic Nano-sized Fogging CO₂ Generators (302). These ultrasonic generators convert CO₂ into a nano-sized fog, significantly enhancing foliar absorption through dedicated CO₂ Inlets (306) strategically placed around the plant canopy. The precise CO₂ concentrations, both direct and fogged, are continuously monitored by integrated CO₂ Sensors (212). Real-time feedback from these sensors is transmitted to the central RTU (203), which dynamically adjusts the CO₂ source and both control valves (304A and 304B) to maintain optimal CO₂ levels, significantly enhancing crop productivity.

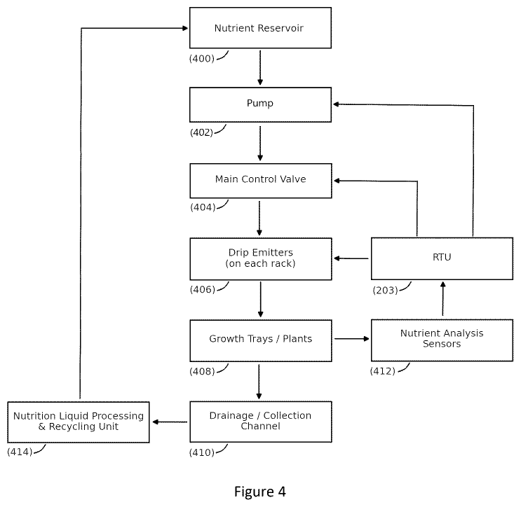

Finally, as depicted in FIG. 4, the invention includes a precisely controlled drip irrigation system. This system begins with a centrally located Nutrient Reservoir (400) supplying nutrient-rich water. The solution is pumped from the reservoir by a Pump (402) and flows through a Main Control Valve (404), allowing precise regulation of nutrient delivery to multiple Drip Emitters (406) located at each rack. These emitters deliver water and nutrients directly into the Growth Trays or Plants (408). Excess nutrient solutions not absorbed by the plants flow into the Drainage/Collection Channel (410), from which they pass into a dedicated Nutrition Liquid Processing and Recycling Unit (414). This unit processes and purifies the nutrient solution, recycling it back into the Nutrient Reservoir (400) for efficient resource usage. Integrated Nutrient Analysis Sensors (412) continuously monitor nutrient solution quality, receiving data directly from the Growth Trays (408) and transmitting results to the centralized RTU (203). The RTU (203) precisely controls the Pump (402), Main Control Valve (404), and Drip Emitters (406) based on real-time nutrient analysis, ensuring optimal nutrient delivery and plant hydration.

This detailed and integrated approach significantly improves cultivation efficiency, environmental control precision, and overall plant health, delivering superior productivity within high-density cultivation environments.

1. A high-density cultivation system for strawberries, leafy greens, herbs, fruits, and flowers, comprising:
a rack assembly configurable as fixed, mobile, or modular units, optionally with wheels or rails, wherein said rack assembly supports one or more layers of growth trays;
a hybrid network communication framework including Wi-Fi, Thread, Bluetooth, Bluetooth mesh, PLC, and industrial communication networks for communication among system components;
at least one AI-enhanced monitoring module including cameras or sensors for real-time plant growth analysis, wherein said AI-enhanced monitoring module generates signals indicative of growth parameters or pest conditions;
a nano size fogging CO₂ delivery system configured to deliver CO₂ generated by ultrasonic or other devices into the rack assembly;
a smart ventilation mechanism for regulating airflow, temperature, and humidity;
a growth lighting system comprising LEDs emitting red, blue, white, far-red, and UV light, wherein the system is controllable by manual settings, preprogrammed automation, or AI to adjust color ratios;
a smart dripping system for water and nutrient delivery, operable by automation or AI control; and
a central controller configured to receive signals from the AI-enhanced monitoring module and adjust at least one of ventilation parameters, lighting parameters, or dripping parameters based on detected plant conditions.

2. The system of claim 1, further comprising at least one storage tank for liquid nutrients, wherein the smart dripping system meters nutrient solution to each layer independently.

3. The system of claim 1, further comprising rails or tracks allowing the rack assembly to be repositioned to adjust aisle spacing.

4. The system of claim 1, wherein the AI-enhanced monitoring module issues alerts upon detecting abnormal plant growth or environmental conditions.

5. The system of claim 1, wherein the AI-enhanced monitoring module includes at least one image sensor configured to detect infrared spectra for plant stress analysis.

6. The system of claim 1, wherein the nano size fogging CO₂ delivery system is synchronized with the smart ventilation mechanism to improve CO₂ distribution.

7. The system of claim 1, further comprising an interactive robot configured for pollination or localized treatment, wherein the robot receives control signals through the hybrid network.

8. The system of claim 1, wherein the growth lighting system includes dimming functionality responsive to ambient light measurements.

9. The system of claim 1, further comprising a user interface accessible via mobile or computing devices for manual override of automated or AI-driven control.

10. The system of claim 1, wherein the smart ventilation mechanism includes distributed humidity and temperature sensors positioned at multiple vertical levels.

11. The system of claim 1, wherein the AI-enhanced monitoring module correlates visual data with nutrient parameters to predict deficiencies.

12. The system of claim 1, wherein the hybrid network includes automatic failover between communication protocols.

13. A method of cultivating plants in a high-density cultivation system, comprising:
arranging racks having sensors, lighting, and CO₂ delivery systems;
establishing a hybrid communication network interconnecting system components;
generating plant growth analytics using AI;
delivering nano size fogging CO₂ while controlling environmental parameters;
modulating growth lighting based on AI or programmed control;
controlling irrigation based on plant conditions; and
performing pest detection and response using AI-based analysis.

14. The method of claim 13, wherein modulating growth lighting includes adjusting red-to-blue ratios based on plant growth stages.

15. The method of claim 13, wherein CO₂ delivery is regulated based on real-time environmental measurements.

16. The method of claim 13, further comprising generating predictive maintenance schedules for system components.

17. The method of claim 13, wherein the AI module improves detection accuracy using historical data.

18. A high-density cultivation rack system comprising:
a rack assembly supporting plant trays;
a hybrid communication platform;
a nano size fogging CO₂ delivery system;
a smart ventilation system;
a growth lighting system; and
a smart dripping irrigation system.

19. The system of claim 18, wherein the rack assembly comprises corrosion-resistant materials.

20. The system of claim 18, further comprising locking mechanisms for stabilizing the rack assembly.
